(19) United States
(12) Patent Application Publication
(10) Pub. No.: US 2006/0026136 A1
(43) Pub. Date: Feb. 2, 2006

(54) Method and system for generating a real estate title report

(75) Inventors: David Drucker, Glen Cove, NY (US); William Welge, Port Washington, NY (US)

Correspondence Address: HOFFMANN & BARON, LLP, 6900 JERICHO TURNPIKE, SYOSSET, NY, 11791, US

(73) Assignee: RealtyData Corp.

(21) Appl. No.: 11/007,941

(22) Filed: Dec. 9, 2004

Related U.S. Application Data
(60) Provisional application No. 60/541,630, filed on Feb. 4, 2004.
(60) Provisional application No. 60/586,853, filed on Jul. 9, 2004.

(51) Int. Cl. G06F 17/30

(52) U.S. Cl. 707/3

(57) ABSTRACT

A method for generating a title report for a target real estate parcel includes the steps of gathering data records pertaining to real estate parcels from a plurality of disparate sources, storing the gathered data records in a common format within a computer database, indexing the commonly formatted data records within the computer database to facilitate searching, searching the indexed data records within the computer database for data records pertaining to a target real estate parcel, selecting at least one record of data pertaining to the target real estate parcel, electronically abstracting pre-selected data directly into an associated file while simultaneously viewing said record and generating a title report containing the pre-selected data in a predefined format. A system for generating a title report for a target real estate parcel includes a computer database containing data records from a plurality of disparate sources, wherein the data records pertain to real estate parcels and are commonly formatted within the database. The system further includes a search algorithm for searching the computer database for data records pertaining to a target real estate parcel and a report building algorithm for electronically abstracting pre-selected data directly into an associated file and generating a title report containing said pre-selected data.

This application claims the benefit of U.S. Provisional Application No. 60/541,630 filed on Feb. 4, 2004 and U.S. Provisional Application No. 60/586,853 filed on Jul. 9, 2004.

### FIELD OF THE INVENTION

The present invention relates generally to methods and systems for investigating title information relating to real estate and, more particularly, to a computer-implemented method and system for collecting and storing real estate-related data, searching the collected data, and generating a real estate title report.

### BACKGROUND OF THE INVENTION

A title search is a typical component of many real estate transactions, and is generally performed prior to the completion of the transaction. As will be appreciated by those skilled in the art, it is quite common for a real estate contract to require that proof of title be provided in order to identify the correct owner(s) of record and/or interests against the property in question. To obtain proof of title, abstractors, alternately known as searchers or examiners, seek out various official records in an effort to confirm ownership of the property in question, to identify any liens recorded against the property, and to identify judgments, bankruptcy proceedings or other such encumbrances which could affect rights in the property. Such a search is usually performed manually at a local government repository, e.g., the county clerk's office.

A typical search process begins with a mortgage bank or other entity placing an order with a title company to conduct a title search on a particular property (e.g., a property on which the bank may extend a mortgage). The title company then instructs one or more abstractors to begin a title search. For example, an abstractor will likely search the records of the local county clerk's office and courthouse, as well as the records of the local tax office. Other governmental sources may also be searched, depending on the location and type of property.

Due to the manner in which most county clerks maintain their real estate records, a property search is generally performed by searching a party's name. All of the instruments filed with the county clerk having that particular name are then identified, resulting in a very large number of documents, particularly if the name is common. The searcher must then review each of the identified documents to determine which ones are relevant. This is, of course, dependent on the abstractor locating the hard copy record and/or microfilm reel containing the needed document. If and when the needed document is located, the required information is generally abstracted off the document onto a “scratch pad”. This process is widely used due to a general lack of adequate copying facilities within a county clerk's office, or the typical delay associated with such copying. It will be appreciated that such delays may involve occupied or broken copy machines, as well as bureaucratic delays if the copying is done by a government employee.

Thus, abstractors are hampered by the government's cumbersome and antiquated methods of storing records, as well as the lack of access to such records outside of normal government business hours. At best, it takes hours to manually search, locate, and review the data required to produce the report. The nature of this process also increases the likelihood of error. For example, the need to manually abstract the required information from an original document to a scratch pad can result in inaccuracies, misspellings or other such mistakes in the report. This can result from transcribing errors, to handwriting illegibly, or to lost or misplaced data sheets.

Once all the information is obtained, the abstractor generally compiles the information in an abstract report and sends the physical report back to the title company. The abstract report is usually sent to a title reader employed by the title company who reviews the report for completeness and accuracy and creates a worksheet. A typist then creates a title report based on the abstract and the worksheet, which in turn is proofread for errors by the proofing department of the title company. If everything is complete and accurate, a finished title report is sent back to the bank.

It will be appreciated that each time the data is handled, the likelihood of error increases. As mentioned, the title searcher reviews the report prepared by the abstractor, but he generally does not have access to the original records viewed by the abstractor (and therefore cannot independently verify the accuracy of such information). The information is then again handled by a separate typist who prepares the final report. This typist is relying upon the worksheet created by the title searcher, who relied upon the abstract report created by the abstractor. As a result, it is not uncommon to carry errors/mistakes forward through the process or to introduce new errors into the report through this process.

Thus, during the typical process, a report is prepared based upon information gathered at a particular government repository (which can be only obtained during normal business hours, e.g., M-F 9-5), such information including manually transcribed notes and data, which is then forwarded to other individuals for further handling. As discussed, copies of the original document may not be readily obtainable for subsequent verification of the data. Moreover, there will be times when it was not possible for the abstractor to locate every document identified in his initial grantor/grantee search. The net effect of the traditional title information gathering system, in addition to increased likelihood of error or mistake, is that it often takes three to five business days to prepare a title report.

There is therefore a need in the art for a system for collecting, sorting and storing of selected real estate-related data in a readily searchable mode, thereby allowing searches to be conducted when needed (not limited by the office hours of the government repository), to be conducted at a remote site, to be able to retrieve all identified records, to be able to readily obtain copies of any such record, and to be completed in a matter of hours rather than days. There is a further need in the art for a system which is adapted to receive and integrate regular periodic updates from various disparate sources, e.g., county clerks' offices. Ideally, this system should be capable of monitoring the quality of the incoming data. There is also a need in the art for a system which provides an improved mode of searching records relating to or affecting the title of a particular property, particularly when searching within a grantor/grantee index system. Finally, there is a need in the art for a system that facilitates the initial preparation of a search report, while reducing the likelihood of error being subsequently introduced into the report.

Thus, it would be desirable to provide an accurate, efficient and cost effective method and system for generating title search reports.

### SUMMARY OF THE INVENTION

The present invention, which addresses the needs of the prior art, relates to a method for generating a title report for a target real estate parcel. The method generally includes the steps of gathering data records pertaining to real estate parcels from a plurality of disparate sources, storing the gathered data records in a common format within a computer database, indexing the commonly formatted data records within the computer database to facilitate searching, searching the indexed data records within the computer database for data records pertaining to a target real estate parcel, selecting at least one data record pertaining to the target real estate parcel, electronically abstracting specific data directly into an associated file while simultaneously viewing such record, and generating a title report containing the requested data in a predefined format.

The present invention further relates to a method of triangulating a search of real estate related records. The method generally includes the steps of searching a first database to identify a first identifier associated with a target real estate parcel, searching a second database to identify records associated with the first identifier, and retrieving the associated records.

The present invention also relates to a method for generating a title report for a target real estate parcel. The method generally includes the steps of searching a computer database containing data records pertaining to real estate parcels, selecting at least one data record pertaining to a real estate parcel from the computer database, electronically abstracting specific data directly into an associated file while simultaneously viewing the selected data record, and generating a title report containing the specific data in a predefined format.

The present invention further relates to a method of compiling a searchable database of real estate-related records. The method generally includes the steps of providing a storage medium for storage of electronic data, establishing a set of data requirements for a selected county, preparing a loading script to funnel incoming data from an original format into a predefined system format, installing the loading script within a data loader and connecting the data loader to the storage medium, accessing a source of real estate-related records from a selected provider through the data loader, determining whether the record of the provider include certain required data, determining whether the records of the provider are maintained in a usable format, determining whether the storage medium is ready to receive the required data contained within the records, and loading the required data from the provider to the storage medium.

Finally, the present invention relates to a system for generating a title report for a target real estate parcel. The system includes a computer database containing data records from a plurality disparate sources, the data records pertaining to real estate parcels and being commonly formatted. The system further includes a search algorithm for searching the computer database for data records pertaining to a real estate parcel. Finally, the system includes a report building algorithm for electronically abstracting specific data directly into an associated file and generating a title report containing the specific data.

As a result, the present invention provides a system for collecting, sorting and storing of selected real estate-related data in a readily searchable mode, thus allowing searches to be conducted when needed, to be conducted at a remote site, to be able to retrieve all identified records, to be able to readily obtain copies of any such record, and to be completed in a matter of hours rather than days. The present invention further provides a system which is adapted to receive and integrate regular periodic updates from various disparate sources. Moreover, the present invention provides a system which is capable of monitoring the quality of the incoming data. The present invention further provides a system which allows an improved mode of searching records relating to or affecting the title of a particular property, particularly when searching within a grantor/grantee index system. Finally, the present invention provides a system that facilitates the initial preparation of a report, while reducing the likelihood of error being subsequently introduced into such report.

The preferred embodiments of the method and system for generating a real estate title report as well as other objects, features and advantages of this invention, will be apparent from the following detailed description, which is to be read in conjunction with the accompanying drawings.

### BRIEF DESCRIPTION OF THE DRAWINGS

FIG. 1 is a block diagram showing the functional components of the system formed in accordance with the present invention.

FIGS. 2a through and 2d are detailed flow charts of the data acquisition and integration process.

FIGS. 3a through 3d are computer screen printouts illustrating the searching steps of the present invention with respect to a Grantor/Grantee Search.

FIGS. 4a and 4b are flow charts illustrating a triangulation search process according to the present invention.

FIG. 5 is a flow chart showing a series of steps performed in the report builder component of the present invention.

FIGS. 6a through 6d are computer screen printouts illustrating a report building process of the present invention.

FIGS. 7a through 7e are printout pages of a sample title report generated by the report building process of the present invention.

FIGS. 8a and 8b are flow charts illustrating the report delivery process of the present invention.

### DETAILED DESCRIPTION OF THE PREFERRED EMBODIMENTS

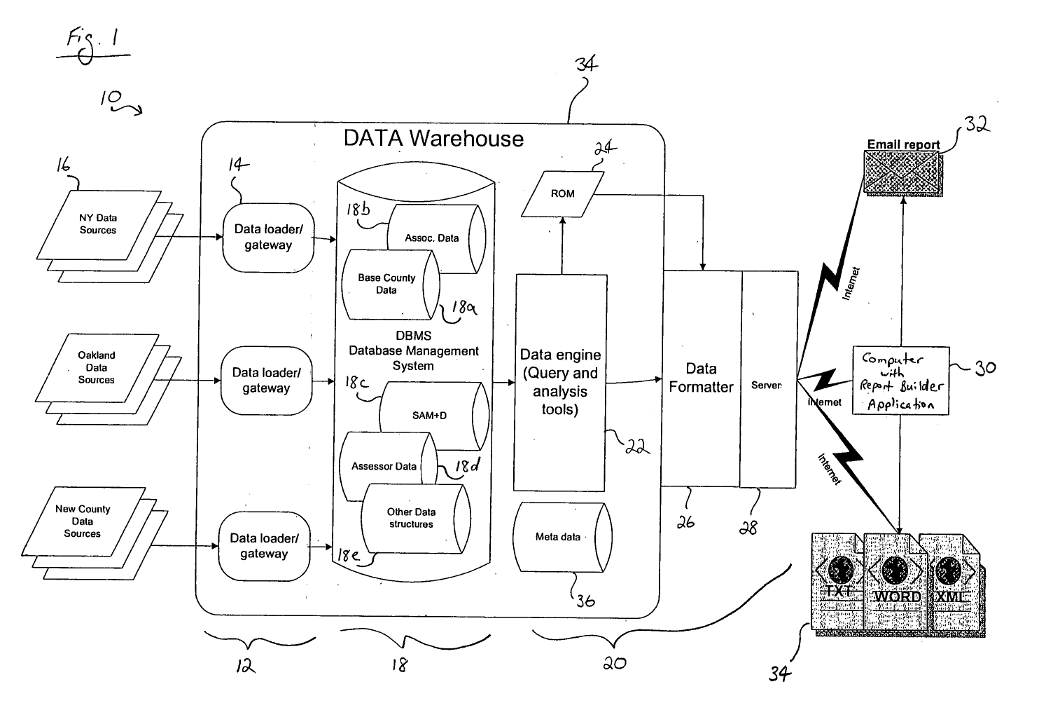

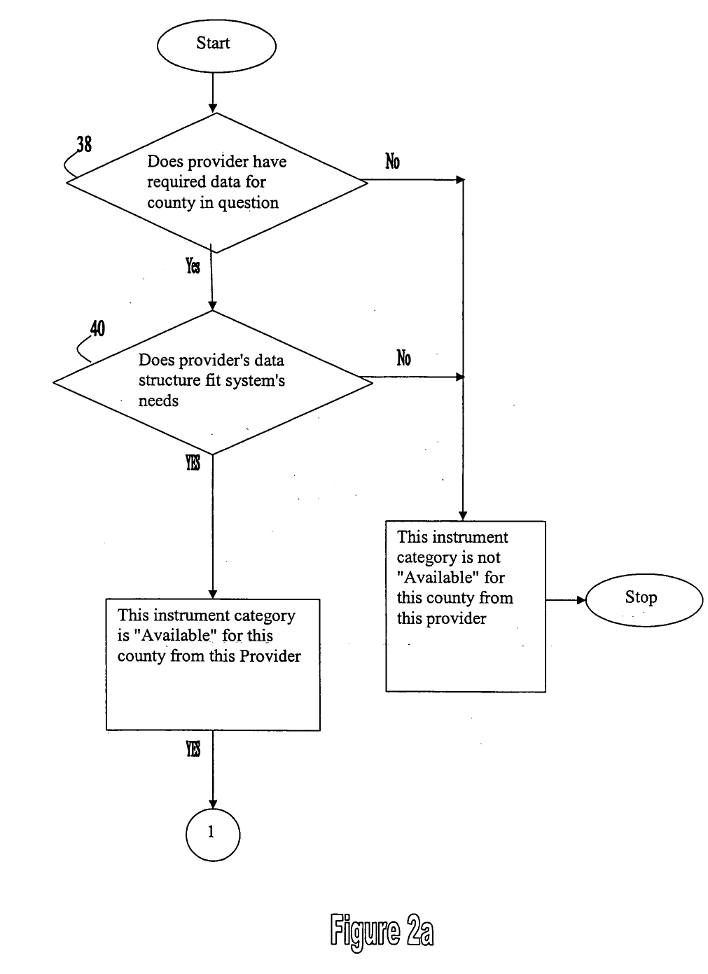

The system according to the present invention can generally be differentiated into five functional components: Raw Data Accumulation; Data Storage; Searching; Report Building; and Report Delivery. FIG. 1 shows these components in block diagram format.

Generally, system 10 includes a data accumulation module 12 having data loaders 14 for gathering real estate data from a plurality of disparate data sources 16. These data sources are preferably grouped by municipal counties. The data loaders 14 index and store the gathered data in a database management system (DBMS) 18 by category or identifiers, for example, assessor data and base county data. Indexes are preferably created on key data search fields to achieve optimal data retrieval performance. Data may also be normalized during this process. In this regard, the normalization of the data allows for consistent storage and efficient access of such data in a relational database.

It will be appreciated that the use of multiple data loaders allows parallel processing to take place, thereby improving loading efficiency while minimizing the processing time which must be spent by the CPU of DBMS 18 to load such data. As a result, the searching capacity of DBMS 18 is not significantly affected. The use of multiple data loaders also increases the reliability of the overall system since the failure of any single data loader cannot affect the operation of DBMS 18.

As will be discussed in further detail below, a search module 20, which includes a data engine 22, a ROM 24, a data formatter 26 and a server 28, cooperates with the DBMS 18 for performing searches of data stored in the DBMS. The data formatter 26 of the search module 20 preferably feeds retrieved data from the DBMS (through server 28) to a remote computer 30, which preferably includes a report builder application for generating a computer viewable title report. Alternatively, the system may bypass remote computer 30 and deliver the search results via alternate report delivery outputs, such as by e-mail 32 or direct transmission to a user's system 33. In one preferred embodiment, the data formatter allows delivery of a report in multiple formats (e.g., Word, XML, HTML, SOAP) to meet the different needs of various clients.

In a preferred embodiment, data accumulation module 12, DBMS 18 and search module 20 are contained in a central data warehouse 34. A “data warehouse” as used herein is defined as a repository of information gathered from multiple sources stored under a unified schema. Thus, the data warehouse provides the user with a single consolidated interface to data, making decision-support queries easier to write. Stated differently, because the data from the disparate data sources has been transformed into a unified format, a common application layer for accessing the data can be utilized. Each of the individual functional modules of data warehouse 34 will be discussed in further detail below.

Raw Data Accumulation

As discussed above, system 10 includes database management system 18, which forms part of central data warehouse 34. However, as will be understood by those skilled in the art, no such database management system or central data warehouse exists in the field of title searching. Thus, this first aspect of the present invention is directed to the initial collecting of raw data from multiple sources (wherein each source likely provides the data in a distinct format), to the sorting and indexing of such raw data, and to the continuing and regular receipt of new and updated raw data from each of the individual data sources.

The system according to the present invention preferably accumulates data from a wide variety of sources. The most common (and usually most extensive) source is the county clerk's (or county recorder's) complete set of real estate records. By themselves, these records may total anywhere from several hundred thousand to several million per county. In addition to real estate transactions, the records of the county clerk typically include judgments and tax liens, both of which can affect title to a property.

Data is also preferably accumulated from sources other than the county clerk, e.g., bankruptcy courts and various local governmental agencies which may record instruments that are unique to a particular jurisdiction (e.g., Environmental Control Board judgments in New York City). More particularly, relevant data is preferably accumulated from each level of government in each particular jurisdiction. All of the mentioned data may be acquired in any number of ways, including FTP, CD, or XML over the Web. The data may be collected directly from the official source or via a third party service.

Returning to FIG. 1, data is loaded from various disparate sources 16 via data loaders 14 into database 18. Upon receipt of the data, the data is analyzed to identify essential data fields, trends and associations. At the receiving end, the data warehouse 34 may use various indexing and table partitioning schemes along with dynamic multithreading to send data about the transfer process and other relevant information to a metadata 36 and warehouse files. It will be recognized that the use of indexing can increase the speed of subsequent searches. One preferred type of index is a sorted list of the contents of a particular table column, with pointers to the row associated with the value. Such an index allows a set of table rows matching some criterion to be located quickly. Partitioning, which is associated with indexing, decomposes very large data tables into smaller and more manageable pieces called partitions.

The data is preferably cleansed during the loading process to identify and correct exceptional conditions. Exceptional conditions are events that occur in a system that are not expected or are not a part of normal system operation. If the system handles an exceptional condition improperly, it can lead to a system failure and/or crash. Robust exception handling in software can improve software fault tolerance and fault avoidance. Many data exceptional conditions can be anticipated when the system is designed, and protection against such conditions is preferably incorporated into the database system. For example, if a piece of incoming data purporting to be a social security number has less than 9 digits, the system would identify an irregularity, and flag such data for inspection.

The data accumulation process in accordance with this first aspect of the present invention is preferably done on a county-by-county basis. The process of adding the records of a new county to DBMS 18 generally involves 1) an initial review and consideration of the reporting requirements for that county; 2) the acquisition and integration of the data for that county; and 3) the periodic updating of the data for that county. If and when all relevant records for a particular county are inputted into DBMS 18, that particular county then becomes available for automated searching in accordance with the present invention.

The initial review and consideration of the reporting requirement for a new county typically involves determining which types of instruments will be needed to provide the required data for the date ranges needed. This can often be accomplished by using an abstractor to retrieve sample records for review and consideration. The acquired sample data is analyzed to determine the strictest set of data requirements. Thereafter, the data types which will be required for that county are reviewed to determine whether they include any non-typical categories which are not part of the usual generic data requirements.

Once the required data requirements for a new county have been established, loading scripts are prepared for that particular county. These loading scripts are preferably loaded into a particular data loader 14 associated with that particular county. The script is written to funnel the incoming data from its original format into the system's selected format, e.g., a common usable format. Once the script and data loader are in place for the county in question, the “data acquisition and integration” step of the data accumulation process is considered.

This data acquisition and integration process generally involves a consideration of whether the required data is available from a particular provider, whether the format of the data from that provider is usable, and whether the system is ready to receive and load the data. The data acquisition and integration process is performed for each instrument category. Generic instrument categories generally include, among others, mortgage and deed instruments, judgments, liens, bankruptcy instruments and UCC filings.

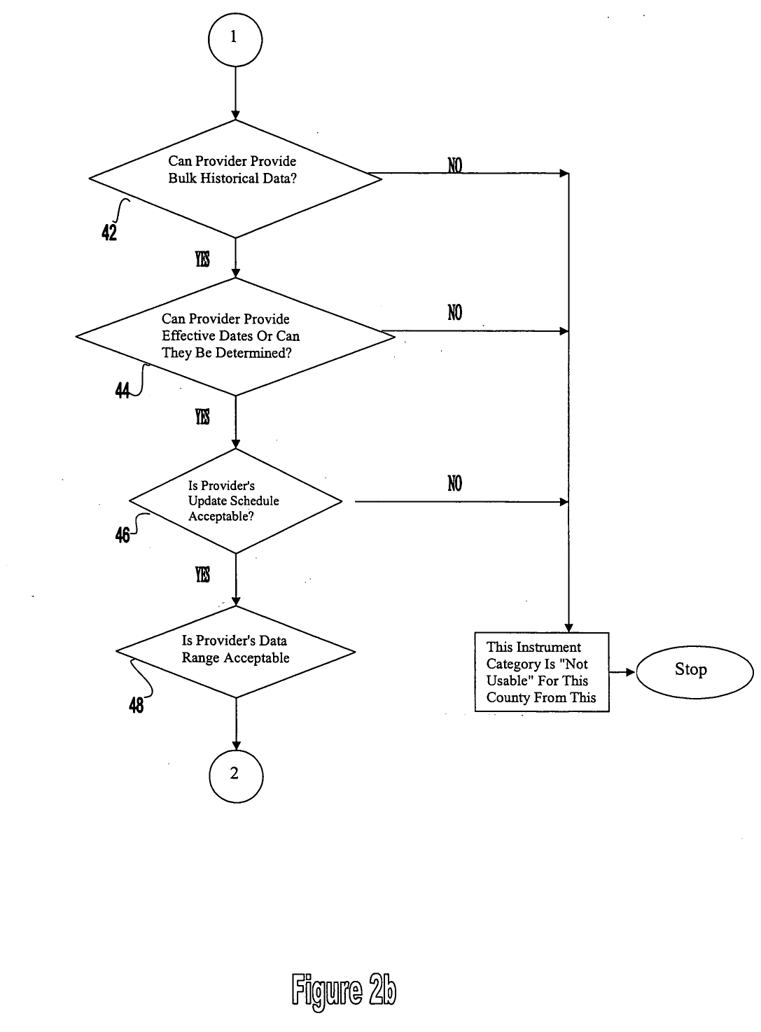

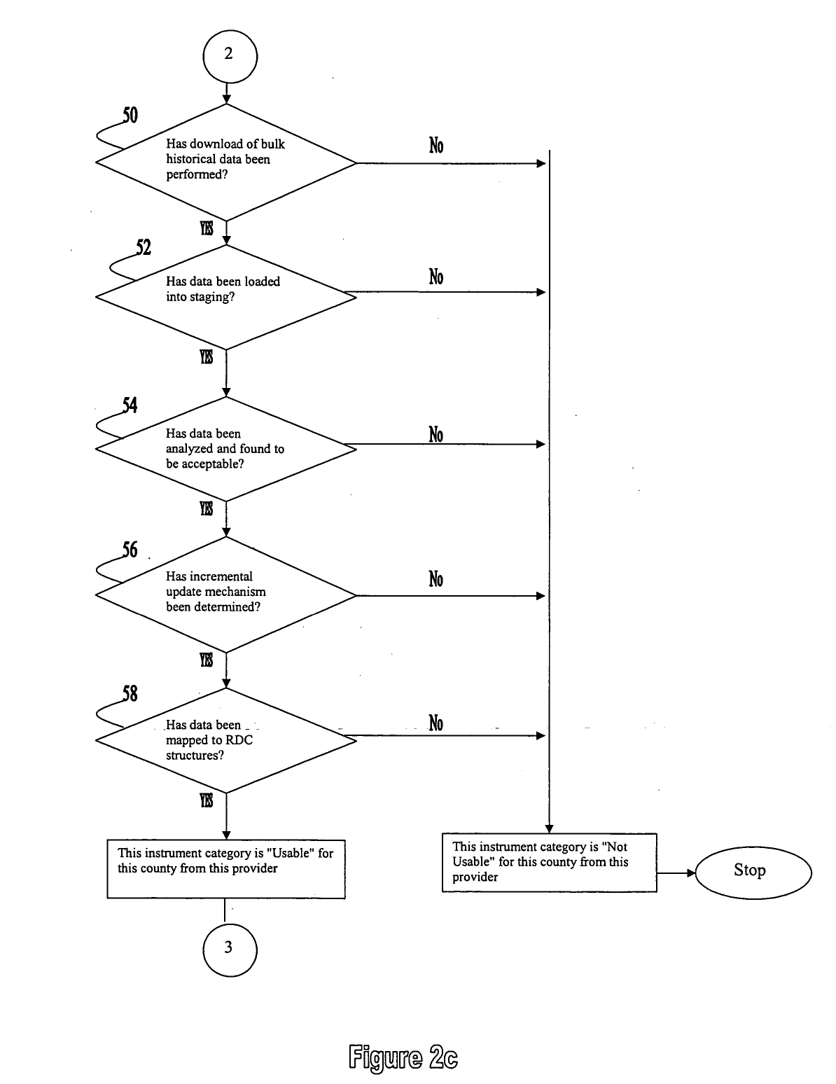

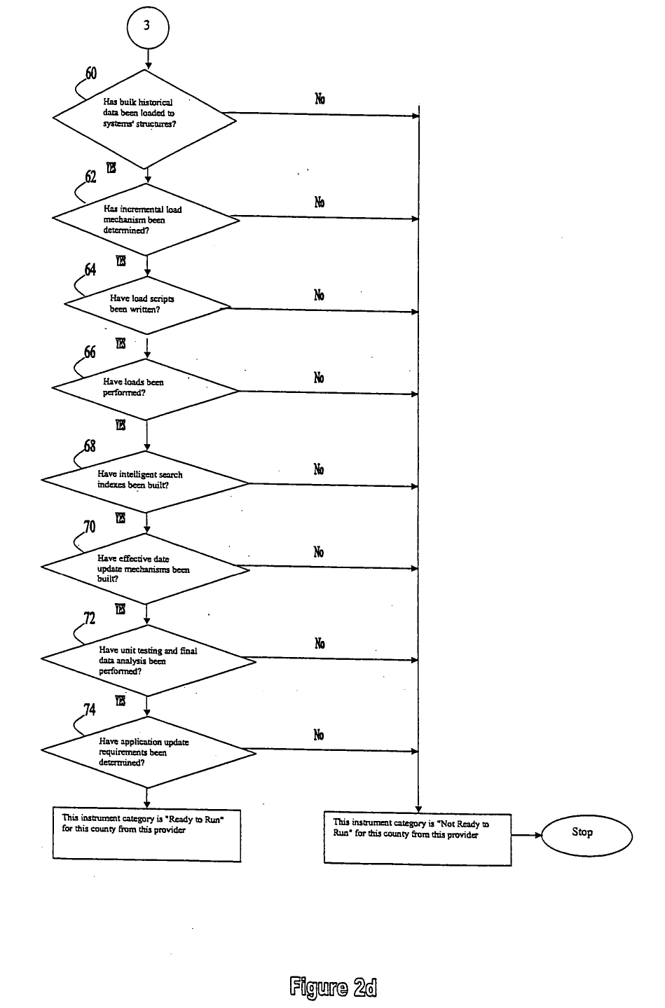

The data acquisition and integration process is shown in FIGS. 2a, 2b, 2c and 2d. The “availability” aspect of the data acquisition and integration process is shown in FIG. 2a. As will be appreciated by those skilled in the art, data can be obtained from various sources, including an official source such as the county clerk or an independent third party data provider. Therefore, it must initially be determined whether the provider in question has the required data for the county in question (step 38). If yes, it must be determined if the provider's data structure fits the system's needs (step 40) (i.e., are all required fields available). If each of steps 38 and 40 has produced an affirmative response, then the instrument category is categorized as “Available” for this county from this provider. If no, the instrument category is categorized as “Not Available” for this county from this provider. An alternative provider must then be located, and the above analysis again conducted for this instrument category.

If the instrument category is available, then a determination must be made as to the “usability” of the data for that county from that provider. The “usability” aspect of the data acquisition and integration process is shown in FIG. 2b and 2c. Accordingly, it must be determined if the provider can provide bulk historical data (step 42), if the provider can provide effective data dates or if the effective dates can be determined (step 44), if the provider's update schedule is acceptable (step 46), and if the provider's date range is acceptable (step 48). If each of steps 42, 44, 46 and 48 has produced an affirmative response, then the analysis is continued. If no, the instrument is categorized as “Not Usable” for this county from this provider. An alternative provider must be located for this instrument category.

The usability analysis continues with an additional series of inquiries: Has download of bulk historical data been performed? (step 50); Has data been loaded into staging? (step 52); Has data been analyzed and found to be acceptable? (step 54); Has an incremental update mechanism been determined? (step 56); and Has data been mapped to system's structures? (step 58). To determine if the data is acceptable in step 54, at least some, and preferably all, of the following questions are asked: Are all required and expected instrument types found in the data?; Have effective dates of actual data been analyzed acceptably?; Have instrument distributions been analyzed acceptably (e.g., a lack of gaps in the data)?; Has any data duplication been found?; Is all data of expected types?; Have document associations (if applicable) been analyzed? If each of steps 50, 52, 54, 56 and 58 has produced an affirmative response, the instrument category is categorized as “Usable” for this county from this provider. If no, the instrument category is categorized as “Not Usable” for this county from this provider. An alternative provider must be located for this instrument category.

If the instrument category is “usable”, then a determination must be made as to the “readiness” of the system. The “readiness” aspect of the data acquisition and integration process is shown in FIG. 2d. In this stage, the following must be determined: Has bulk historical data been loaded to system's structure? (step 60); Have incremental load mechanisms been determined? (step 62); Have load scripts been written? (step 64); Have loads been performed? (step 66); Have intelligent search indexes been built? (step 68); Have effective update mechanisms been built? (step 70); Has unit testing and final testing analysis been performed? (step 72); Have application update requirements been determined? (step 74). If each of steps 60, 62, 64, 68, 70, 72 and 74 have produced an affirmative response, the instrument category is categorized as “Ready to Run” for this county from this provider. If no, the instrument category is categorized as “Not Ready” for this county from this provider.

In one preferred embodiment, information retrieval indicators are added to the data upon loading which provides data warehouse 34 with information retrieval logic. These indicators help to estimate data relevance and return only highly ranked data during searching. By accessing information for decision support from a data warehouse, the decision maker ensures that online transaction processing is not affected by the decision-support workload. This is achieved by separating the online transaction processing component from the decision-support component. Moreover, the data loading aspect of the present invention is easy to expand in that only a new data loader needs to be added if, for example, a new county is added to the database. All other components remain the same.

Data Storage

All the various types of data the system utilizes are preferably transformed to a common set of structures when stored within DBMS 18, i.e., the data is transformed into a common usable format. This is preferably accomplished via prewritten scripts and exceptions management which have been customized for the county, the provider, and the type of data being acquired such that the desired data may be loaded and irregularities identified.

Specifically, the system preferably includes an Oracle database, which indexes the stored data appropriately to facilitate the types of searches that may be executed by a user. For example, the stored data may be indexed into county data 18a, county associated data 18b, stand alone mortgage (SAM) data 18c, assessor data 18d and other data structures 18e. In addition, advanced indexing is utilized in all fields related to individual and corporate names to ensure that the user's search returns all names similar to the names entered. In order to accommodate such indexing, a twenty terabyte SAN for storing the data is preferred.

Inasmuch as real estate filings occur every day, and the system's database must be as up to date as possible, load procedures are preferably run daily.

Searching

Using computer 30, which is connected to data warehouse 34 through server 28, a user can conduct a search relating to a target real estate parcel. The present invention provides the user with various user-interactive computer screens to facilitate the search.

A user's search typically consists of one or more names relating to the target real estate parcel within a date range. The name(s) may also be designated as one of several “party types” on an instrument. The searching algorithms are preferably optimized to return the most accurate result, while allowing the user the flexibility to determine how “close” the names returned must match the names entered. For example, a “wide” search against the name “Smith” may return results including “Smythe”, but a narrow search would not.

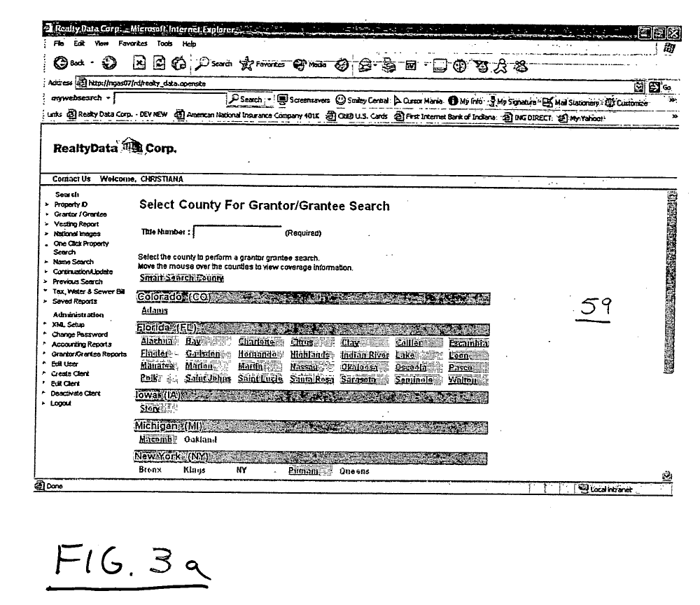

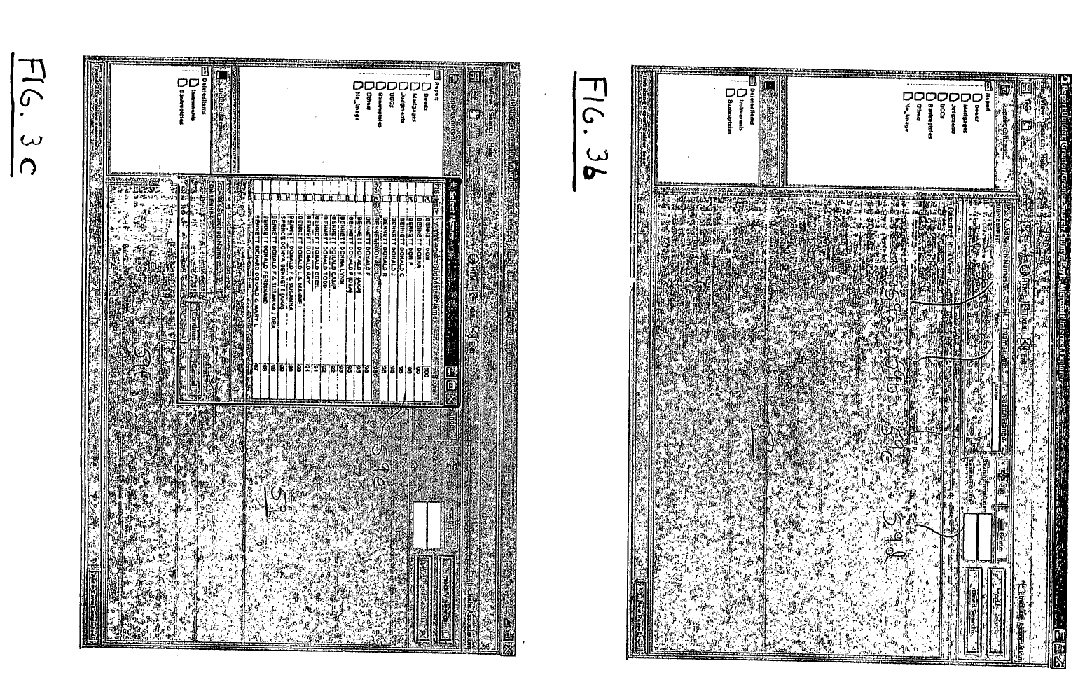

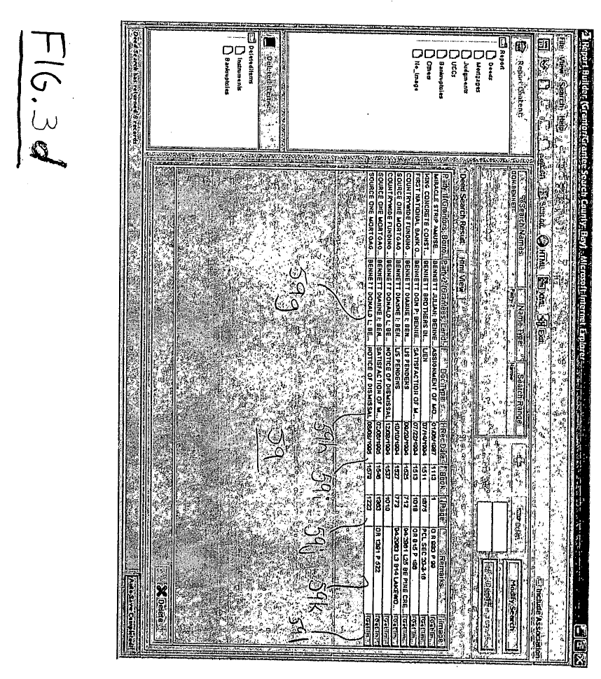

FIG. 3a illustrates a sample computer screen 59 which may be presented to a user when initiating a search. The user is presented with a list of options for the types of searches available. For example, the user may conduct a property ID search, a Grantor/Grantee search, a name search, etc. In any event, the user is also presented with a list of states and counties within the states for which data is available. The user can simply click on the desired county and begin the search.

To perform a Grantor/Grantee search, as shown in FIG. 3b, a user must search by the grantor/grantee names. The present invention preferably utilizes a name searching algorithm, wherein a user can search for a name by entering in the name (in any format, including nick names) in one field 59a of the computer screen, selecting the party (either Party 1, Party 2, or All Parties) in another field 59b, and then specifying the search range (either Narrow, Medium, or Wide) in another separate field 59c. Also, the user can search for multiple names by choosing to add more names in the name field 59a and can also specify a date range for searching within a date range field 59d of the computer screen. Once the user submits the name search, all names matching the search criteria will be returned from the database in a list, as shown in FIG. 3c, along with a numerical ranking 59e for how close the names found in the database match the names entered by the users. The user then can select the names they are interested in and click a “Continue” button 59f on the computer screen and the system retrieves all of the documents containing those names. Numerous other techniques can be made available to restrict or broaden the search criteria, or to perform specialized searches such as finding a deed for a given property which is older than a deed already in the report.

The instruments matching those names selected will then appear in a report builder field 59g of the computer screen 59, as shown in FIG. 3d. As will be discussed in further detail below with respect to the report builder, each instrument can be tagged or identified with various identifying templates or information, such as by document type 59h, recordation date 59i, book and page number 59j and any other remarks 59k. Additionally, as will also be discussed below, the actual image of each document is available by clicking a “Get Image” button 59m on the computer screen and, once the system has retrieved the image, the user is presented with a “View Image” button. The user can now view the image by clicking the “View Image” button.

In addition to name searches, the present invention provides searching based on a unique property identifier (e.g., a “block and lot” or a “Parcel Identification Number”). In counties where this is available, searches are significantly quicker and easier than in counties where it is not available. The availability of the unique property identifier is determined by the laws in each county.

In a preferred embodiment, the present invention utilizes a search method termed “triangulation.” Triangulation is a process by which a property search can be significantly enhanced by utilizing both official county clerk (or county recorder) data, as well as data obtained from third party data providers or other sources (e.g., a tax assessor database) in a unique manner. This process has the effect of transforming a property search in a Grantor/Grantee County (a slow, laborious, and error-prone task) into an effort very similar to a property search in a Block and Lot County, thus making the search quicker, easier, and more accurate.

In a block and lot county, every parcel of real estate is assigned a unique property identifier. This identifier can take various forms. In New York City, for example, a property is identified by its block number and lot number. In other counties, a property may be identified by subdivision and range, or by a number referred to as a Parcel Identification Number (PIN). In these counties, every document referencing a parcel of real estate is indexed according to that property's unique identifier, and this index is available for searching. Therefore, in a block and lot county, in order to locate all the instruments relevant to a particular piece of property, one only needs to know the block and lot (or PIN, or other identifier), and then all of the instruments filed against that property can be easily retrieved.

In a grantor/grantee county, while properties may or may not be assigned unique identifiers, instruments filed with the county clerk are not regularly indexed with this number. They are generally indexed only with the recording date of the instrument, and the parties referenced on it.

In order to perform a property search in a grantor/grantee county, one needs to know the names of the parties for whom the search is to take place. Then, all of the instruments filed with those names are retrieved. This can result in a very large number of documents, if the names are fairly common. For example, in the case of a common name, such as Smith or Jones, such a search will yield an extremely large number of records, most of which are irrelevant. The searcher must then review each of these documents to determine if they are relevant to the search they are performing (i.e., if they refer to the people and property under consideration). This is typically done by reading the Legal Description of the property referenced on the document, as most instruments filed against real estate must contain the full legal description of the property.

When building a chain of title, as the searcher identifies the most current deed for a piece of property by performing a name search against deeds and finding the deed with the correct names and correct legal description, they may then want to find older deeds for the same property. This is done by finding the names of the people who sold the property on the last deed, and then performing another search of deeds using the names of these sellers. This is obviously a tedious and time consuming process, and is prone to error if the searcher is not extremely diligent.

The triangulation process of the present invention greatly reduces this search process. Briefly, in the method according to the present invention, at least one database category of data other than the county database category is searched for relevant identifying information before searching the county database category. The relevant identifying information found as a result of this preliminary search is then used to limit the number of hits when subsequently searching the county data. Thus, according to the present invention, at least two types of data are searched to select records having common identifying elements.

Triangulation has the capability of substantially transforming a grantor/grantee search into a block and lot search by enriching the county data with third party data. In one preferred embodiment, data obtained from various data aggregators is utilized to triangulate searches. Typically, data aggregators obtain copies of many of the county clerk instruments in the jurisdictions in which they do business (usually complete deed and mortgage coverage for a given county, including both purchase money mortgages and standalone mortgages). These aggregators usually assign each property a unique identifier, which is selected by the aggregator. When these aggregators index county clerk instruments, they include this unique identifier, thus adding a searchable property identifier to every instrument they index where there was none in the original data.

By utilizing this third party data, a search according to the present invention can determine a unique property identifier for a particular property (by address or owner name), and then retrieve all of the instruments indexed with this property identifier. Since a user is generally interested in county clerk data, the instruments retrieved from the third party data are used to point to the corresponding instrument in the county clerk data, and these instruments are presented to the user.

This third party data may cover only a limited timeframe, so the data retrieved by such a search may not encompass all of the clerk data available. Accordingly, the searcher may have to supplement the search with a traditional grantor/grantee type search, but the work which must be performed has been greatly reduced by the addition of this third party data. In this manner, not all “Smith” records will be pulled from the county database. Instead, only “Smith” records having, for example, the common identifier assigned by the aggregator, will be selected. Thus, the overall search time and effort can be greatly reduced.

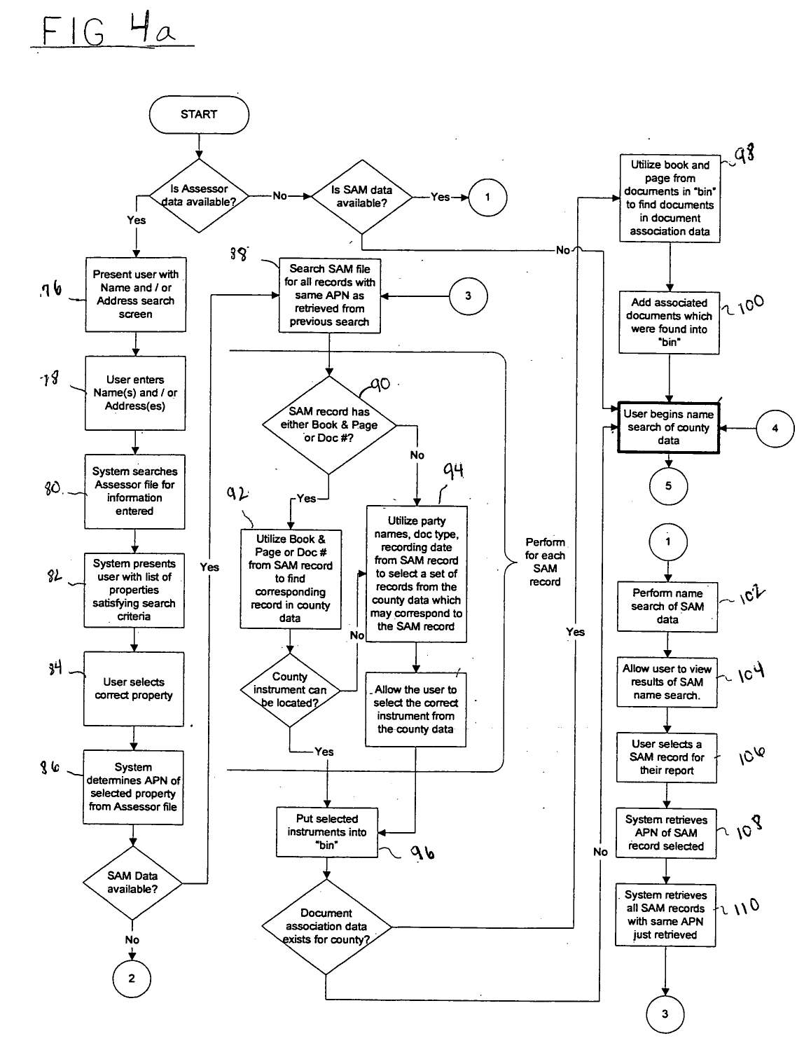

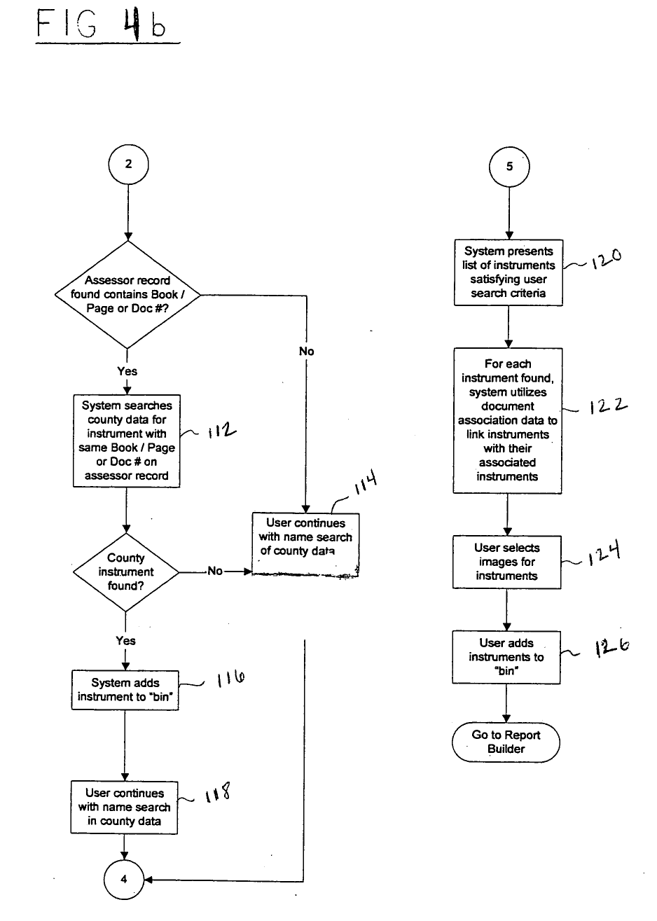

FIGS. 4a and 4b are flow charts illustrating the triangulation method according to the present invention. First, a tax assessor database 18d having property records indexed by address and owner name is searched prior to searching the county Grantor/Grantee database 18a and its associated database 18b. Accordingly, a searcher would input a name and/or a property address (steps 76, 78) and the system would search the assessor file 18d for the entered information (step 80). The system presents the user with a list of properties satisfying the search criteria (step 82) and the user selects the correct property (step 84). For each hit, the system ascertains any additional identifiers, such as the assessors parcel number (APN) or tax receipt dates, that may be attached to the record (step 86).

For example, a search of the tax assessor database may reveal that Peter A. Smith began paying taxes on the property in question on Jan. 1, 2000. Thus, the deed transferring ownership of the property to Peter A. Smith was likely recorded in the county clerk's office within a window of time surrounding Jan. 1, 2000. As a result, the search results can be sorted by date to highlight the documents falling within this window.

The system then searches a second database, such as a mortgage related document database 18c, for records having one or more common identifiers that were entered or found in the prior database (step 88). Next, additional identifiers, such as block and lot number or page and document number, are ascertained (step 90). The system can now search the county database 18a for records having common identifying elements found as a result of the prior searches (step 92, 94). The system then puts the selected instruments into a “bin” (step 96). If document association data exits for the selected county data, the book and page number from the documents in the “bin” is utilized to find documents in the document association database 18b (step 98). These documents, in turn, are also added to the “bin” (step 100).

If tax assessor data 18d is not available and, for example, only Stand Alone Mortgage (SAM) data 18c is available, a user can perform a name search of the SAM data (step 102) and view the results of the SAM name search (step 104). The user then selects the desired SAM records (step 106) and the system retrieves a property identifier (e.g., APN) for the selected record (step 108). The system then retrieves all SAM records having the same property identifier (step 110) and searches the corresponding county data 18a as described above with respect to steps 88-96.

If, on the other hand, tax assessor data 18d is available but SAM data 18c is not available, the system turns to the county data 18a and searches for instruments with the same book/page number or document number as found on the selected assessor records (step 112). If the assessor records do not have a book/page number or document number or if no county instruments are found having these property identifiers, the user continues with a name search of the county data (step 114). Otherwise, any instruments found as a result of the book/page number or document number search is added to the “bin” (step 116) and the user continues with a name search of the county data (step 118).

The above process can further be repeated for other databases 18e. In all scenarios, however, the user comes to a point where a name search is conducted in the county and associated data records 18a and 18b. The system presents the user with a list of instruments satisfying the entered user search criteria (step 120). For each instrument found, the system utilizes all of the document identifiers ascertained as a result of the foregoing searches and links the instruments with their associated instruments (step 122). Preferably, each instrument is linked to a computer viewable image of that particular instrument. The user can then retrieve and view any of the images associated with each instrument (step 124) and add the desired instrument to the “bin” (step 126). At this point the search is complete and the retrieved documents can be sent to the data formatter 26 and on to remote computer 30 or on to an alternate report delivery means, e.g., e-mail 32.

Report Building

After a user has performed the searches relevant to his or her reporting needs, the search results must be organized, edited, and annotated. The report builder component of the present invention is specifically designed to perform this task. It allows the user to rearrange the search results, group the instruments into logical components, edit and annotate the data in the search results, as well as view full-size scanned images of the original documents. The edited report is then saved in a backend database, and may be retrieved by the user at any time for further editing or review. The report builder component of the present invention is preferably a web-based application, and may be written in a language such as Java.

As mentioned above, the data stored in warehouse 34 contains various sets of data fields. However, in most instances, the data contained in the database is not sufficient by itself to determine if a given document should be included in a report, and a scanned image of the document must be viewed. Therefore, the report builder component preferably includes an integrated real-time image retriever/viewer. Oftentimes, images are available directly from the county clerk/recorder or from a third party image provider. In a preferred embodiment, the report builder's image retrieval mechanism automatically determines if an image is available and from which provider it is available, and when selected by a user, the image is retrieved and displayed to the user in a matter of seconds.

Once a user has selected a document to include in his or her report, the report builder allows the user to select one of several available electronic templates, and to associate this template with the document. Templates are preferably available for such usual documents as deeds, mortgages, judgments, as well as other typical documents which could be retrieved. Each template includes a set of fields which has been pre-selected to correspond with the type of data typically located on that particular type of document. Because the user may require additional fields, report builder 28 preferably provides the ability to customize templates on a client-by-client basis, giving each client the desired fields.

For example, as shown in FIG. 5, after a user has conducted a search, an instrument can be selected from the group of instruments found in the search (step 128). Once selected, an image of the instrument is displayed along with a separate viewing area on the computer screen termed an electronic template associated with that instrument (step 130). The template may, for example, be entitled “Legal Description” and may simply contain a blank field which allows the user to input any desired information seen in the image of the instrument in a free format. Preferably, the electronic template is pre-formatted to include a plurality of data fields corresponding to the instrument, and is preferably pre-populated with the known data associated with this instrument, e.g., the names of the grantor and grantee (step 132). The user is then prompted to enter data into respective fields of the template (step 134). Once the desired information has been entered into the respective data fields of the electronic template, the template becomes attached to the instrument and the system may categorize the instrument within the title report based on the information in the template (step 136). This will save the legal description for future reference and searching. This information is then transported along with the image into the final title report.

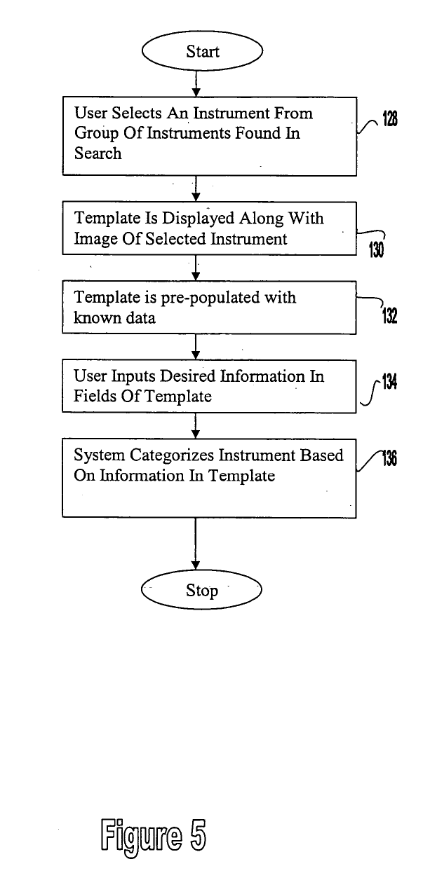

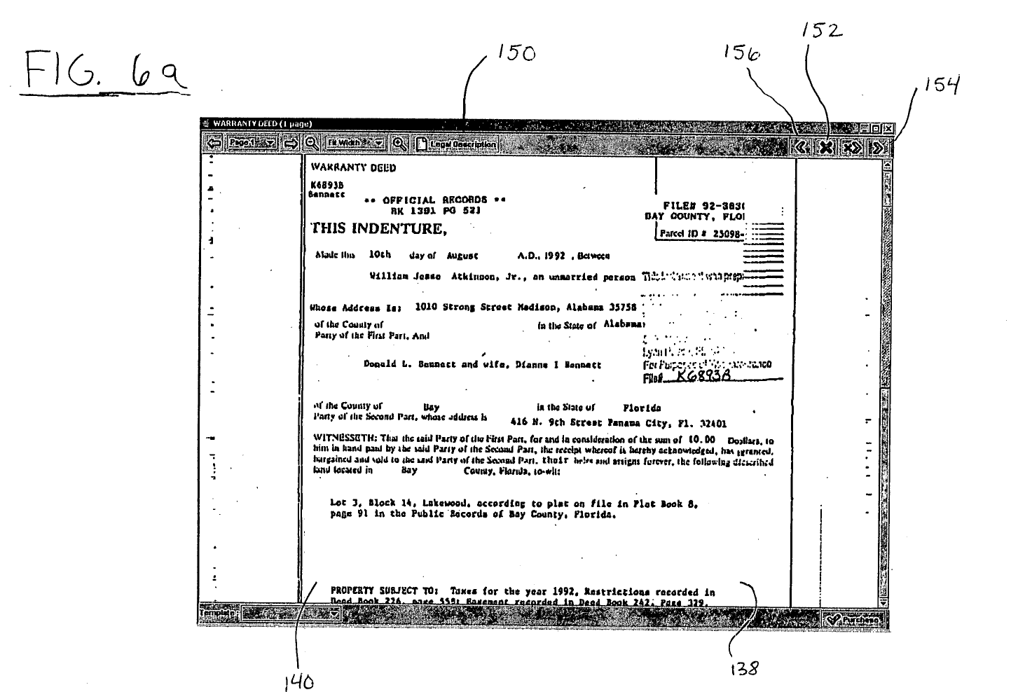

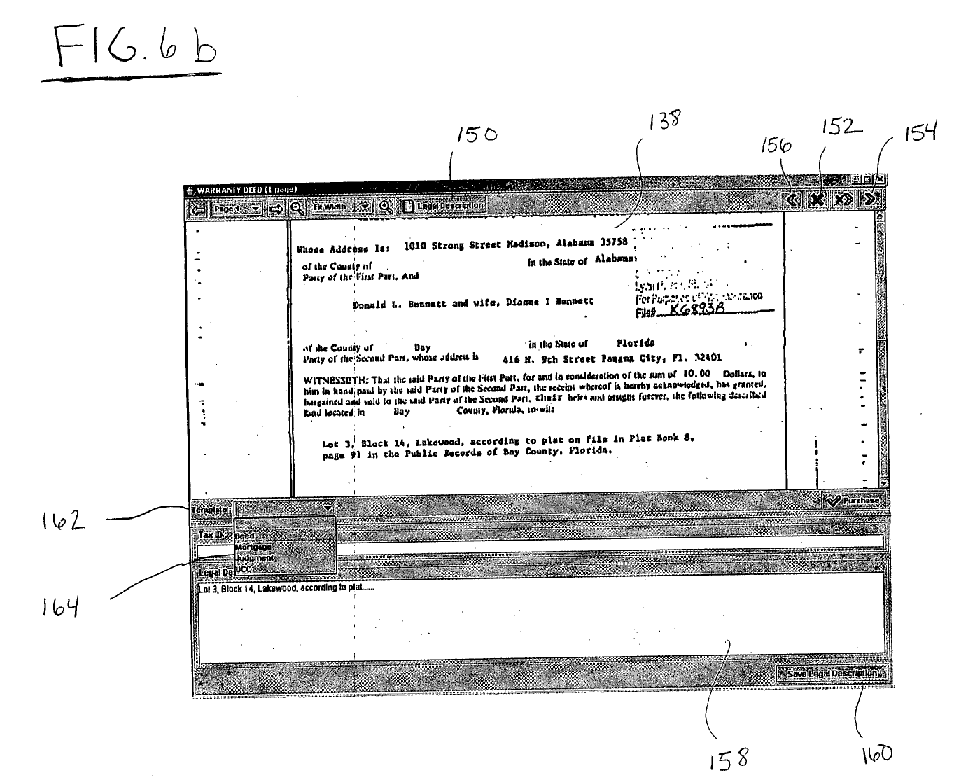

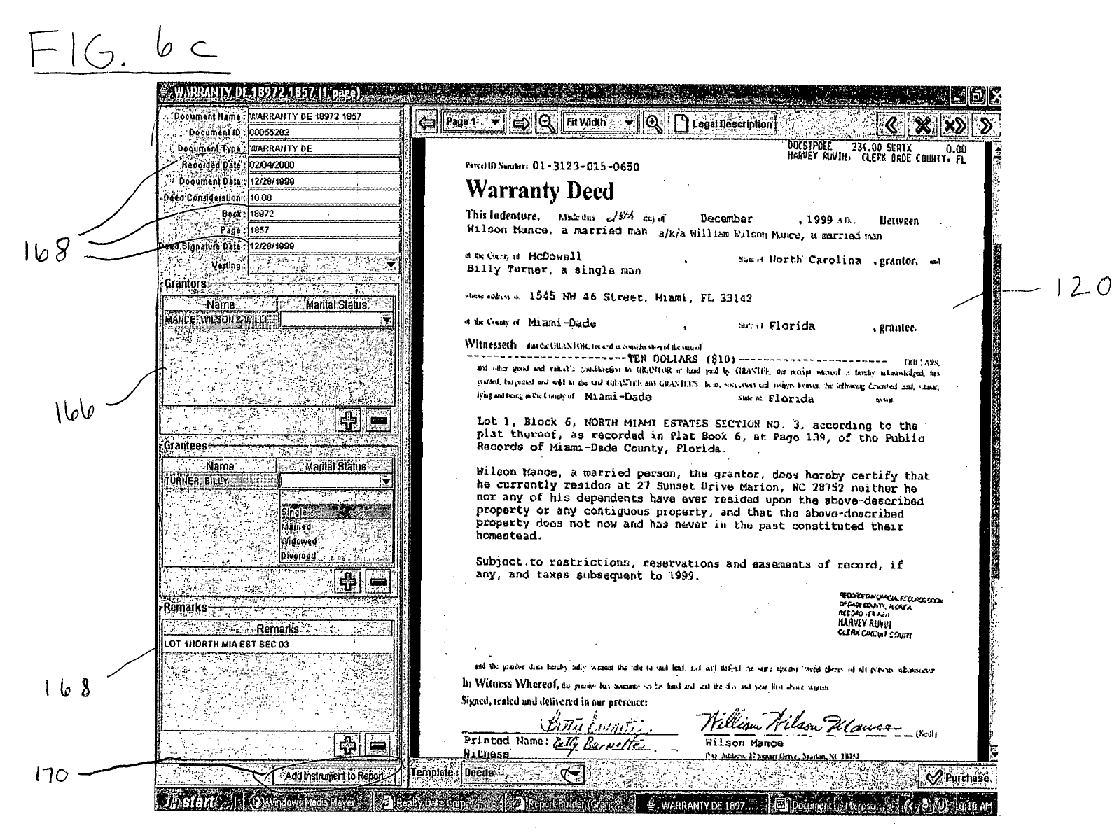

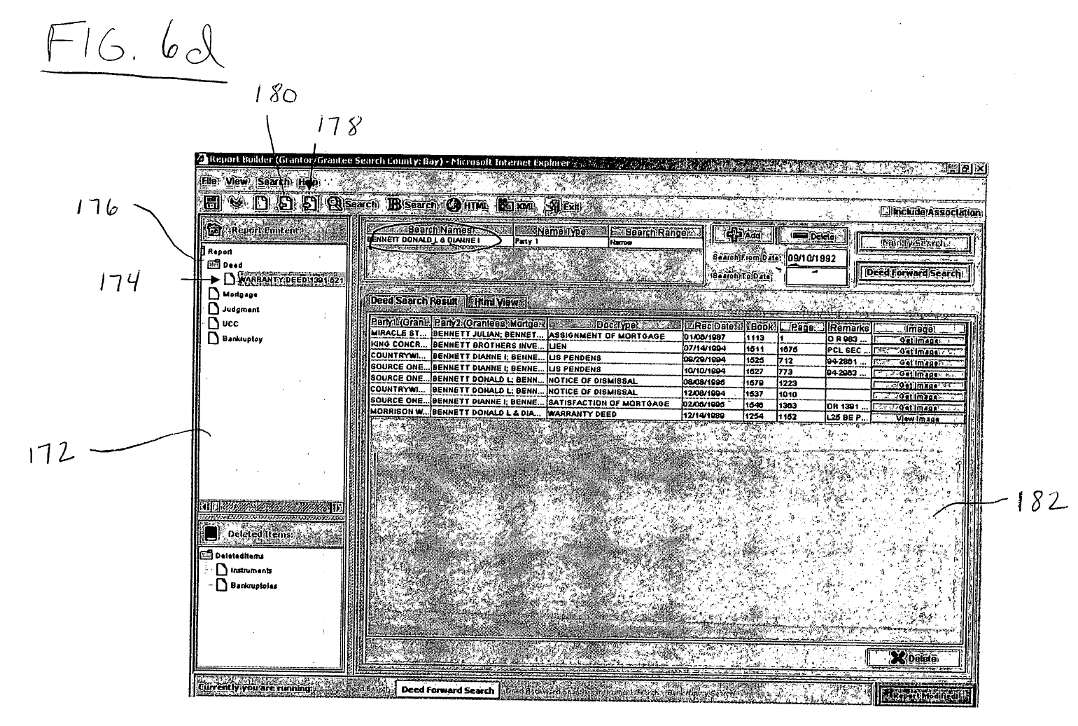

FIGS. 6a-6d are sample computer screen shots further illustrating the above steps. In particular, when the “View Image” button is clicked, an actual image 138 of the selected document is displayed on the computer screen 140, as shown in FIG. 6a. If it is determined that the selected property should be included in the report, the user may select a “Legal Description” button 150 on the computer screen, which will bring up a template in which the user may enter desired information. If, on the other hand, the instrument is not desired, the user may click on an “X” button 152 to delete the selected instrument from the report. The user is also preferably provided with forward (“>”) and reverse (“<”) buttons 154 and 156 to enable the user to scroll through the images.

When the “Legal Description” button 150 is selected, a separate legal description screen 158 is displayed to the user alongside the instrument image 138, as shown in FIG. 6b. The user can then enter any desired description from the instrument image 138 into the legal description screen 158 in a free format. This can be done be typing or using a cut and paste feature wherein selected text from the instrument image 138 can be copied to the legal description screen 158. After entering the legal description, the user may select a “Save Legal Description” button 160 to save the entered information for future reference.

Also, a pre-formatted template may be applied to the instrument by selecting a “Template” button 162 on the computer screen. Selection of the “Template” button 162 preferably displays a drop-down menu 164 allowing the user to choose a pre-formatted template type which is suitable for the particular instrument. Such pre-formatted template types may include “Deed,” “Mortgage,” “Judgment” or “UCC.” Once a template type is chosen, another separate screen called the template screen 166 is displayed to the user alongside the instrument image 138, as shown in FIG. 6c. The template screen 166 includes a plurality of information fields 168 which allow the user to enter specified information from the instrument image. Such information fields may include document date, marital status, and miscellaneous remarks. This information will also be transported into the report after an “Add Instrument” button 170 is selected on the template screen 166.

Once the instrument has been added to the report, the template screen 166 disappears and a report content screen 172 appears listing the name of the added instrument 174 grouped under its respective template type 176. Additionally, adding an instrument to the report automatically adds the names that are on the report into the user's search parameters. Furthermore, in the case of deed instruments, adding a deed to the report automatically changes the present search date to the date when the selected deed 176 was transferred. Such search date changing feature is beneficial since in most cases a searcher will only want to retrieve subsequent deeds to confirm that the selected deed is indeed the last deed. Alternatively, the system can provide the user with a “Search Forward” button 178 on the computer screen which will initiate a search beginning with the date of a selected deed instrument. In like manner, a “Search Backward” button 180 may be provided on the computer screen enabling the user to search in the opposite direction.

Clicking on any instrument in the report content screen 172 will display its associated template in the right panel 182 of the screen. The user may then also be presented with “Edit,” “Save” and “Delete” options to modify and save the templates as desired as the user compiles the report. Also, various customizable filters may be employed which will enable the user to retrieve only templates of a desired type or in a desired date range.

Thus, in addition to editing document-level fields, the system of the present invention provides the user with the ability to collect documents into various groups, to rearrange the documents into any preferred order, to delete unwanted items, or to edit report-level information. Moreover, the user has the ability to save the work which has been performed, or to retrieve a report which was worked on previously.

Report Delivery

The report generated by the Report Builder component of the present invention can be provided in a number of formats. Generally, title companies may have differing needs for utilizing the data found in the report and, therefore, several different output mechanisms are supplied. For those requiring printouts, the system of the present invention will preferably provide reports in HTML, plain text, and automatically formatted MS-Word documents.

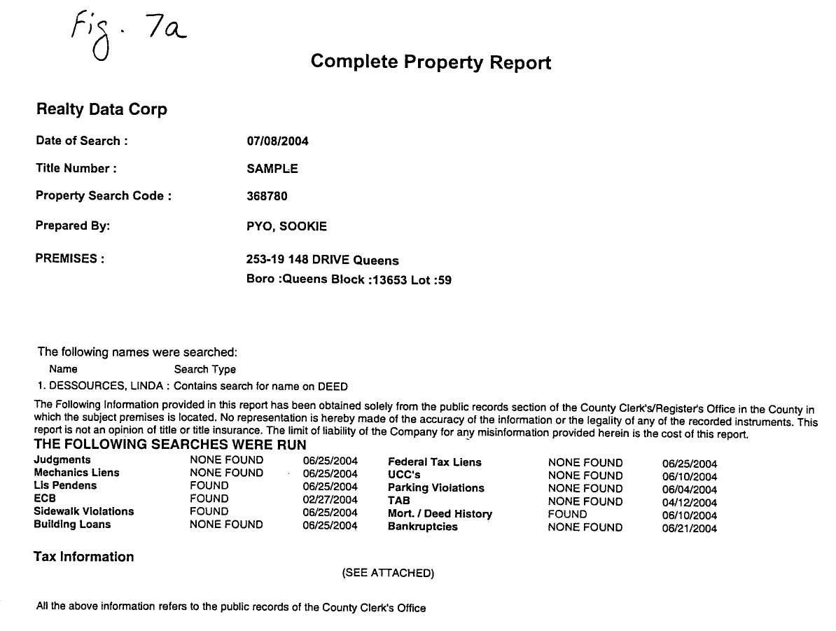

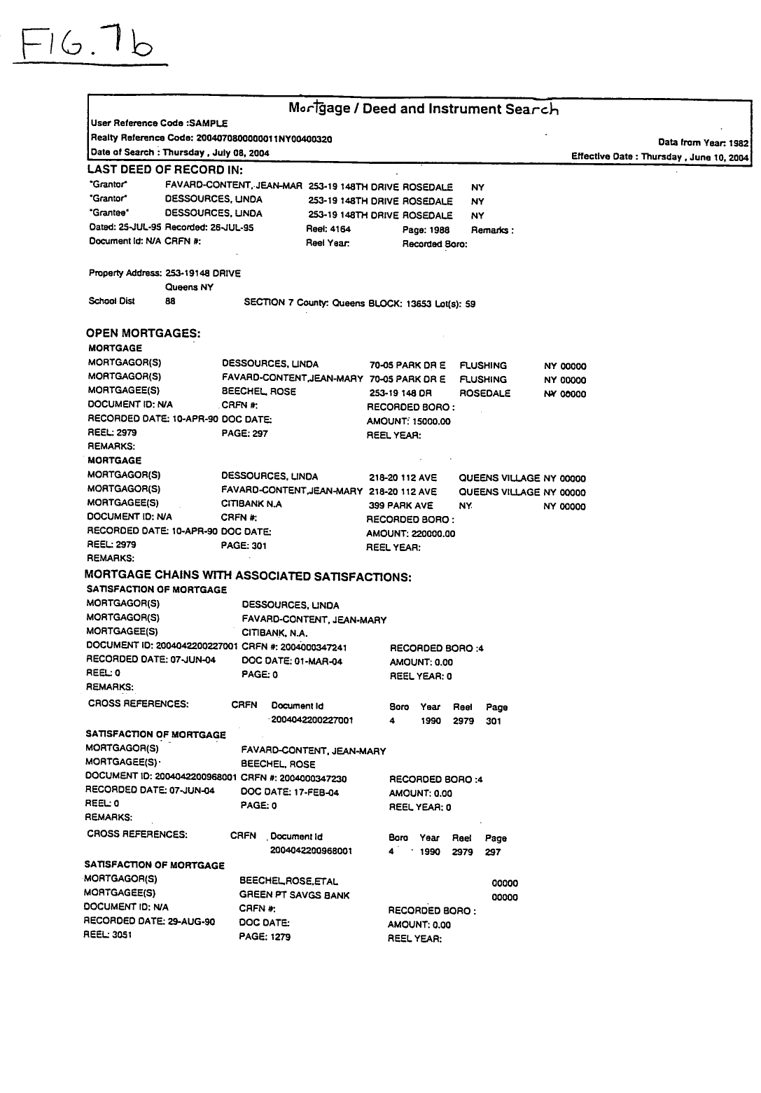

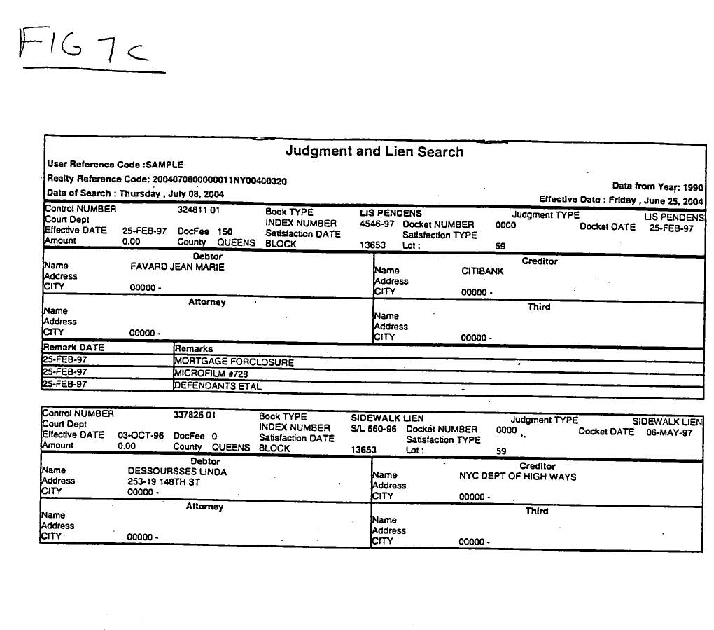

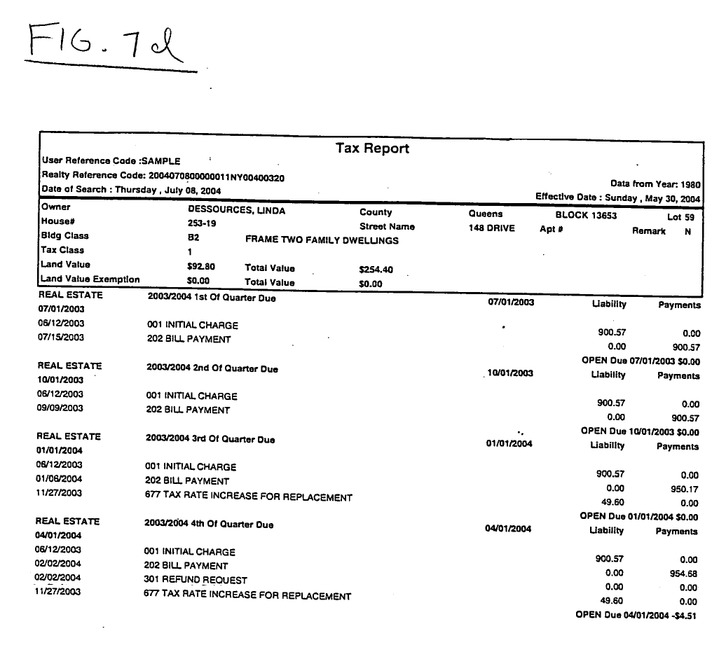

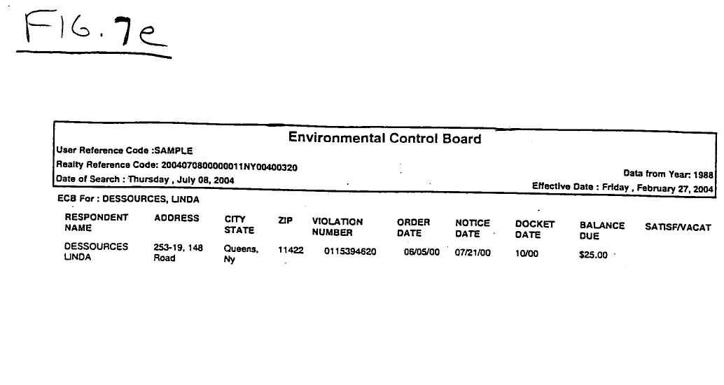

A sample printed report is shown in FIGS. 7a-7e. FIG. 7a shows a summary page showing all the instruments, by type, found as a result of the search. The following pages of the report list the instruments by type in more detail. For example, FIG. 7b lists all the Mortgage and Deed instruments, FIG. 7c lists all the Judgment and Lien instruments, FIG. 7d lists all the tax instruments and FIG. 7e lists Environmental Control Board instruments. The information associated with each listing is preferably retrieved from the template applied to that particular instrument during the report building process. Additionally, while not shown in FIGS. 7a-7e, the final report will also preferably include printout images of the actual instruments listed in the report.

Alternatively, the report may be electronically formatted to be compatible with a title company's particular computer system. Thus, the present invention eliminates the traditional chore of typing the contents of a report into a title company's internal systems. Specifically, the present invention preferably provides a direct XML interface allowing companies equipped to accept an XML feed of their report directly into their internal systems, thus completely eliminating the need to re-type any report data. This significantly cuts down on the time required for a user to complete a report.

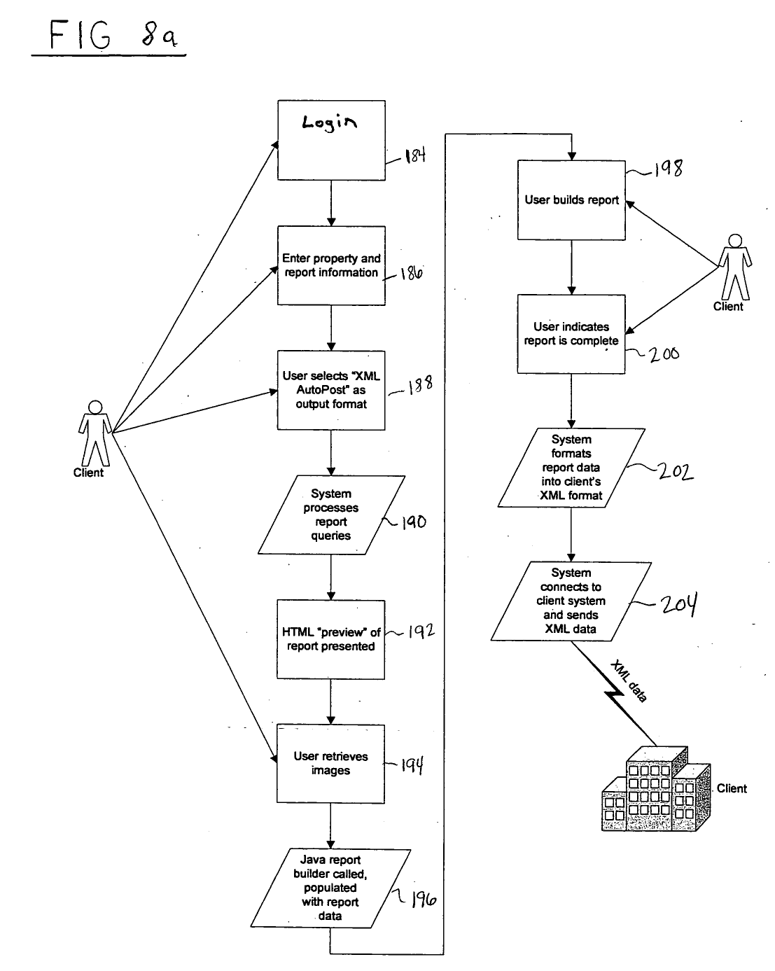

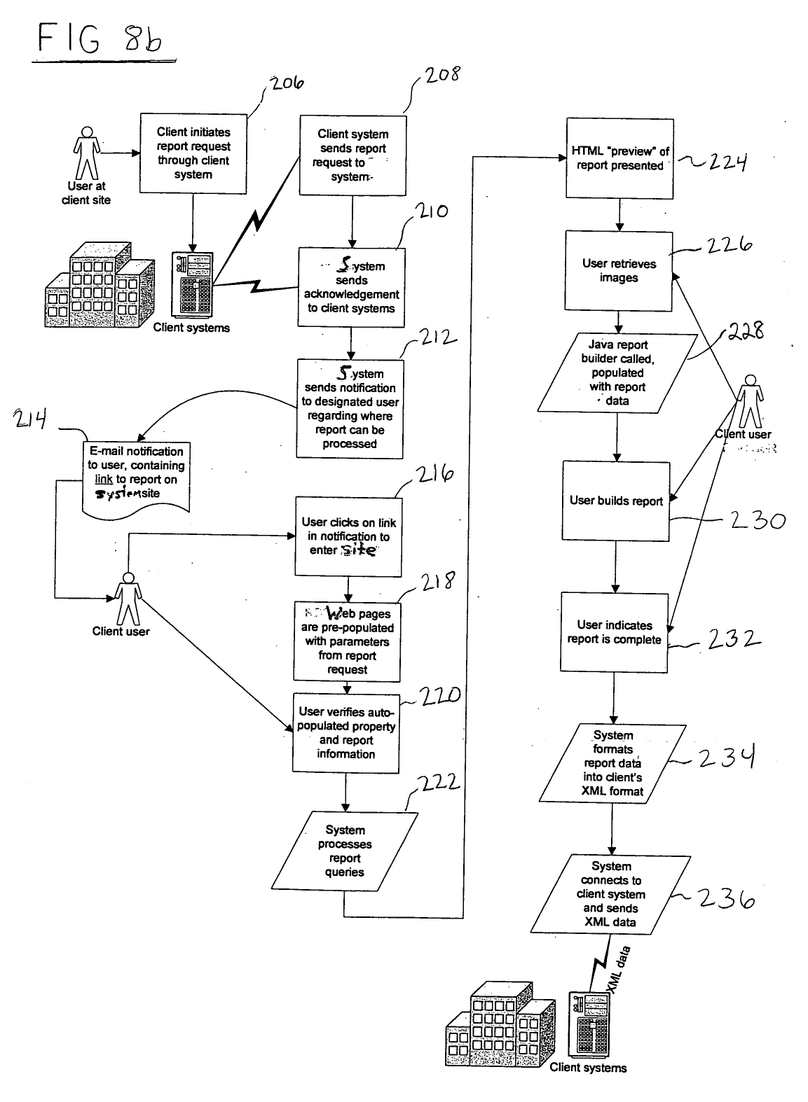

FIGS. 8a and 8b illustrate the report delivery process of the present invention. FIG. 8a illustrates the scenario where a user generates an XML posting interactively from the system of the present invention via a website. Specifically, the user first logs into the website (step 184) and enters the property and report information with respect to a target real estate property (step 186). In this case, the user selects “XML Auto Post” as the output format for the title report (step 188). The system performs the requested search (step 190) and displays (step 192) a preview of the title report, as described above. The user may then select and retrieve images (step 194) and establish electronic templates with respect to the selected instruments (step 196), thereby building a title report (step 198). When the user indicates that the report is complete (step 200), the system formats the report data into the user's XML format (step 202) and sends the XML report to the user's system (step 204).

Alternatively, as shown in FIG. 8b, a user's site may auto-post a report request to the system and the user or a customer service representative may execute the report. Specifically, the user initiates a report request through his own computer system (step 206) and the user's system sends the report request to the system of the present invention (step 208). The system according to the present invention sends an acknowledgement to the user's system (step 210) along with a notification to the user regarding where the report can be processed (step 212). This notification can be via e-mail containing a computer link address to the website of the system (step 214), whereby the user can click on the link to enter the system's website (step 216). The system then displays to the user web pages that are pre-populated with parameters from the report request (step 218) and the user verifies the auto-populated property and report information (step 220). If all is correct, at this point the system processes the search (step 222) and displays the search results (step 224). The user may then select and retrieve images (step 226) and establish electronic templates with respect to the selected instruments (step 228), thereby building a title report (step 230). When the user indicates that the report is complete (step 232), the system formats the report data into the user's XML format (step 234) and sends the XML report to the user's system (step 236), as described above.

In addition to these core systems, the system may also run a variety of other systems which support other revenue-generating products. These include client management, order management, financial reporting, administrative, and accounting systems, which can be built from the ground up or purchased, as deemed appropriate.

Thus, as a result of the present invention, a system is provided which implements client-specific XML integration, whereby the contents of a title report are transmitted from the report builder directly to a client's backend systems via XML. The client system then imports this data, thus completely eliminating the need to retype a report which can run to multiple pages. Additionally, when reports are saved to the system's backend database, the internal Java object representation of the report is converted to an equivalent XML format, transmitted by the report builder over the Internet from the user's computer to the system's backend database, where they are saved. When retrieving a previous report, the same process is executed in reverse.

Although the preferred embodiments of the present invention have been described with reference to the accompanying drawing, it is to be understood that the invention is not limited to those precise embodiments, and that other changes and modifications may be made by one skilled in the art without departing from the scope or spirit of the invention.

What is claimed is:

1. A method for generating a title report for a target real estate parcel, comprising the steps of:
gathering data records pertaining to real estate parcels from a plurality of disparate sources;
storing said gathered data records in a common format within a computer database;
indexing said commonly formatted data records within said computer database to facilitate searching;
searching said indexed data records within said computer database for data records pertaining to a target real estate parcel;
selecting at least one data record pertaining to said target real estate parcel;
electronically abstracting specific data directly into an associated file while simultaneously viewing said record; and
generating a title report containing said requested data in a predefined format.

2. The method according to claim 1, wherein said searching step comprises the further steps of:
performing a first search for data records using a first searching criteria;
ascertaining a first identifier from data contained in a pre-selected data field of at least one data record found as a result of said first search;
performing a second search for data records having said first identifier; and
outputting data records associated with said first identifier.

3. The method according to claim 2, wherein said first identifier is selected from the group consisting assessors parcel numbers, tax receipt dates and parcel identification numbers.

4. The method according to claim 3, further comprising the steps of:
ascertaining a second identifier from data contained in a pre-selected data field of at least one record found as a result of said second search;
performing a third search for data records having said second identifier; and
outputting data records having common first and second identifiers.

5. The method according to claim 2, wherein said second search further comprises the step of identifying a locating index for retrieving said associated record.

6. The method according to claim 1, wherein said indexing step includes the further step of assigning a property identifier to each data record.

7. The method according to claim 6, wherein said searching step comprises the further steps of:
performing a first search for data records using a first searching criteria;
ascertaining said property identifier assigned to said target real estate parcel from at least one data record found as a result of said first search;
performing a second search for data records having said property identifier; and
outputting data records associated with said property identifier.

8. The method according to claim 1, wherein said abstracting step includes the further steps of:
selecting a template having preformatted input fields corresponding to said selected data record;
electronically associating said template with said selected data record; and
compiling said template into said title report.

9. The method according to claim 8, wherein said associating step includes the further step of pre-populating said template with predefined data associated with said selected data record.

10. The method according to claim 1, further comprising the step of editing said at least one record of data prior to generating said title report.

11. The method according to claim 1, further comprising the step of arranging said at least one record of data prior to generating said title report.

12. The method according to claim 1, further comprising the step of pre-setting a range of data records to be retrieved in said searching step.

13. The method according to claim 1, wherein said data is gathered from at least a municipal county real estate record repository.

14. The method according to claim 1, wherein said predefined format is a computer viewable format, said computer viewable format including an actual image of said selected record.

15. The method according to claim 1, wherein said data records include a plurality of data fields.

16. A method for triangulating the search of real estate-related records, comprising:
searching a first database to identify a first identifier associated with a target real estate parcel;
searching a second database to identify records associated with said first identifier; and
retrieving said associated records.

17. The method according to claim 16, wherein said first identifier is an assessors parcel number.

18. The method according to claim 16, wherein said first identifier is a tax receipt date.

19. The method according to claim 16, wherein said first identifier is a parcel identification number.

20. The method according to claim 16, wherein said second searching step further comprises the step of identifying a locating index for retrieving said associated records.

21. The method according to claim 20, wherein said locating index includes a page and document number.

22. The method according to claim 16, wherein said second searching step further comprises the step of identifying a second identifier; and
further comprising the step of searching a third database to identify records associated with either of said first and second identifiers.

23. A method for generating a title report for a target real estate parcel comprising the steps of:
searching a computer database containing data records pertaining to real estate parcels;
selecting at least one data record pertaining to a target real estate parcel from said computer database;
electronically abstracting specific data directly into an associated file while simultaneously viewing said selected data record; and
generating a title report containing said specific data in a predefined format.

24. The method according to claim 23, wherein said abstracting step includes the further steps of:
selecting a template having input fields corresponding to said selected data record;
electronically associating said template with said selected data record; and
compiling said template into said title report.

25. The method according to claim 24, wherein said associating step includes the further step of pre-populating said template with predefined data associated with said selected data record.

26. The method according to claim 24, wherein said compiled report is a computer-viewable format including an actual image of said selected record.

27. The method according to claim 23, further comprising the step of editing said selected data record.

28. The method according to claim 23, further comprising the step of arranging said template in a desired order in said title report.

29. A method of compiling a searchable database of real estate-related records, comprising:
providing a storage medium for storage of electronic data;
establishing a set of data requirements for a selected county;
preparing a loading script to funnel incoming data from an original format into a predefined system format;
installing said loading script within a data loader and connecting said data loader to said storage medium;
accessing a source of real estate related-records from a selected provider through said data loader;
determining whether said record of said provider include certain required data;
determining whether said records of said provider are maintained in a usable format;
determining whether said storage medium is ready to receive said required data contained within said records; and
loading said required data from said provider to said storage medium.

30. The method according to claim 29, wherein said loading step further includes the step of indexing and partitioning said predefined data within said storage medium to facilitate subsequent searching of said predefined data.

31. The method according to claim 29, further comprising the step of validating the accuracy of said predefined data by comparing said required data to a known set of criteria.

32. The method according to claim 29, wherein said loading step occurs on a regular periodic basis.

33. The method according to claims 29, wherein said first determining step further includes the step of determining whether said records of said provider include all required data fields.

34. The method according to claim 29, wherein said second determining step further includes the steps of:
a) determining whether said provider can provide bulk historical data;
b) determining whether said provider can provide effective data dates or whether effective dates can be determine;
c) determining whether said provider has an acceptable update schedule; and
d) determining whether said providers date range is acceptable.

35. The method according to claim 30, wherein said third determining step further includes the steps of:
a) determining whether bulk historical data has been loaded into said storage medium;
b) determining whether incremental load methods have been determined;
c) determining whether load scripts have been written;
d) determining whether loads have been performed;
e) determining whether intelligent search indexes have been built;
f) determining whether effective update mechanisms have been built;
g) determining whether unit testing and final testing analysis has been performed; and
h) determining whether application update requirements have been determined.

36. The method according to claim 30, wherein said loading step further includes the step of attaching information retrieval indicators to said required data upon loading of said data in two set storage medium, said information retrieval indicators including information retrieval logic to facilitate subsequent searching.

37. A system for generating a title report for a target real estate parcel comprising:
a computer database containing data records from a plurality of disparate sources, said data records pertaining to real estate parcels and being commonly formatted;
a search algorithm for searching said computer database for data records pertaining to a target real estate parcel; and
a report building algorithm for electronically abstracting specific data directly into an associated file and generating a title report containing said specific data.

38. The system according to claim 37, wherein said report building algorithm generates a single computer readable title report containing images of discrete data records in a computer viewable format.

39. The system according to claim 37, wherein said report building algorithm includes an editing algorithm for arranging and editing said data pertaining to said target real estate parcel.

40. The system according to claim 37, wherein said search algorithm utilizing a triangulation process for limiting retrieval of non-relevant documents.
